(19) United States
(12) Patent Application Publication
(10) Pub. No.: US 2004/0038071 A1
(43) Pub. Date: Feb. 26, 2004

(54) Sacrificial material and aluminum alloy cladding material for heat exchanger

(75) Inventor: Yuji Yoshidomi, Tokyo (JP)

Correspondence Address: FOLEY AND LARDNER, SUITE 500, 3000 K STREET NW, WASHINGTON, DC, 20007, US

(73) Assignee: CALSONIC KANSEI CORPORATION

(21) Appl. No.: 10/634,764

(22) Filed: Aug. 6, 2003

(30) Foreign Application Priority Data
Aug. 22, 2002 (JP) 2002-241813

(51) Int. Cl. C22C 21/10; B32B 15/10

(52) U.S. Cl. 428/654; 420/540

(57) ABSTRACT

A sacrificial material, which has a cladding material and is laminated on one side of a core material, is made of an aluminum alloy comprising 1.0% to 10.0% by weight of Zn, 0.3% to 0.5% by weight of Si, 0.4% to 3.0% by weight of Ni, and the balance of Al and unavoidable impurities.

### BACKGROUND OF THE INVENTION

1. Field of the Invention

The present invention relates to an aluminum alloy to be used as a constituent member of a heat exchanger requiring an excellent corrosion resistance over a wide pH region ranging from alkaline atmosphere to acidic atmosphere. More particularly, the invention relates to a sacrificial material and an aluminum alloy cladding material for a heat exchanger installed in an automobile. When an aluminum alloy heat exchanger such as automobile radiator and heater core is produced by brazing in an inert gas atmosphere with a fluoride-based flux or by vacuum brazing, the sacrificial material and the aluminum alloy cladding material can be used to form its constituent members such as heat transfer pipe and plate material. In particular, the sacrificial material and the aluminum alloy cladding material can be used to obtain a structure which can be provided with an excellent corrosion resistance even in an alkaline atmosphere where an aqueous solution containing LLC (Long Life Coolant) normally used in the heat exchanger or underground water having a high pH value is circulated as a coolant at a high flow rate (in erosive and corrosive atmosphere).

2. Description of the Related Art

As a heat transfer pipe constituting the core of an automobile radiator and a heater, there has heretofore been used a tubular member obtained by brazing or high frequency-welding a three-layer brazing sheet laminated with a sacrificial material made of an Al—Zn-based alloy to a laminate comprising a brazing material made of an Al—Si-based or Al—Si—Zn-based alloy laminated on one side of a core material made of an Al—Mn-based alloy on the other side of the core material.

For example, a heat transfer pipe 1 as shown in FIG. 1 is formed by a cladding material 2, which is a three-layer brazing sheet. The cladding material 2 has a structure that a brazing material 4 and a sacrificial material 5 are laminated on the respective side of a core material 3. The brazing material 4 is used to cover the periphery of the heat transfer pipe 1 formed by the cladding material 2 and braze the periphery of the heat transfer pipe 1 to a corrugated fin (not shown). The sacrificial material 5 is used to cover the inner surface of the heat transfer pipe 1 thus finished, preventing the progress or occurrence of corrosion in the cladding material 2 in the direction along the thickness of the plate material by a working fluid (cooling water) flowing through the heat transfer pipe 1, thereby preventing occurrence of so-called pitting coorrosion.

As a cladding material 2 which is most normally used to constitute the heat transfer pipe 1, there has heretofore been known a laminate comprising JIS3003 Al alloy (Al—Mn-based alloy comprising from 1.0% by weight to 1.5% by weight of Mn, from 0.1% by weight to 0.2% by weight of Cu, not greater than 0.6% by weight of Si, not greater than 0.75% by weight of Fe, not greater than 0.10% by weight of Zn and the balance of Al and unavoidable impurities) as a core material 3 having a sacrificial material 5 made of JIS7072 material which is an Al—Zn-based alloy and a brazing material 4 made of an Al—Si-based or Al—Si—Zn-based alloy provided on the respective side thereof.

In the case where a heat transfer pipe 1 is formed by such a known three-layer cladding material 2, the working fluid flowing through the heat transfer pipe 1, if it is a relatively low temperature solution which is neutral or weakly acidic and contains Cl ion, exerts an excellent sacrificial anode effect. In other words, since the potential of the sacrificial material 5 covering the inner surface of the heat transfer pipe 1 is lower than that of the core material 3, the sacrificial material 5 undergoes sacrificial corrosion by the aforementioned working fluid, preventing the corrosion by the working fluid from extending to the core material 3. On the other hand, the brazing material 4 covering the periphery of the heat transfer pipe 1 brazes the heat transfer pipe 1 to the aforementioned fin.

However, in the case where the heat transfer pipe 1 is formed by a known aluminum alloy cladding material 2 as mentioned above and the working fluid flowing through the heat transfer pipe 1 is an alkaline solution having a pH value of not lower than 10, desired corrosion resistance cannot be sufficiently secured, making it more likely that the aforementioned corrosion can cause the occurrence of through-holes.

### SUMMARY OF THE INVENTION

Under above-described circumstances, diversified experiments and studies were made of how a core material and a sacrificial material should be combined such that when the voltage potential difference between the core material and the sacrificial material is utilized to cause the sacrificial material to be preferentially corroded, the sacrificial material can be entirely corroded, making it possible to prevent partial occurrence of deep corrosion. The present invention has thus been worked out. An object of the invention is to realize an aluminum alloy cladding material for heat exchanger having an excellent alkaline corrosion resistance which can be provided with an excellent corrosion resistance even when used in an atmosphere where exposed to alkaline working fluid circulating at a high flow rate (erosive and corrosive atmosphere).

In order to achieve the object, according to a first aspect of the invention, there is provided a sacrificial material for heat exchanger made of aluminum alloy comprising, by weight percent, 1.0% to 10.0% of Zn, 0.3% to 0.5% of Si and 0.4% to 3.0% of Ni, with the balance being aluminum including unavoidable impurities.

In order to achieve the object, according to a second aspect of the invention, there is provided an aluminum alloy cladding material for heat exchanger including: a core material made of aluminum alloy comprising, by weight percent, 0.3% to 2.0% of Mn, 0.1% to 1.0% of Cu and 0.3% to 2.0% of Si, with the balance being aluminum including unavoidable impurities; and a sacrificial material made of aluminum alloy provided on one surface of the core material, wherein the sacrificial material comprising, by weight percent, 1.0% to 10.0% of Zn, 0.3% to 0.5% of Si and 0.4% to 3.0% of Ni, with the balance being aluminum including unavoidable impurities.

According to the first and the second aspect of the invention, the aluminum alloy cladding material can be obtained which exhibits an excellent alkali resistance and maintains a sufficient corrosion resistance and thus can protect the aluminum alloy cladding material itself against development of through-holes even when exposed to an alkaline acting fluid circulating at a high flow rate.

### BRIEF DESCRIPTION OF THE DRAWINGS

The above objects and advantages of the present invention will become more apparent by describing preferred exemplary embodiment thereof in detail with reference to the accompanying drawings, wherein:

FIG. 1 is a partial sectional drawing illustrating a heat transfer pipe made of an aluminum alloy cladding material for heat exchanger to which the invention applies.

### DETAILED DESCRIPTION OF THE PREFERRED EMBODIMENTS

Hereinafter, functions and advantages exerted by an incorporation of various alloying components in a sacrificial material and an aluminum alloy cladding material for heat exchanger of the invention will be described in detail. Among these alloying components, Ni, which is incorporated in the sacrificial material, is the most important component. The component of Ni causes an Al—Ni-based compound to be finely dispersed in a matrix, preventing a deposition of aluminum hydroxide, which is a film-forming component, on a site on a surface of the material where the Al—Ni-based compound is produced and hence inhibiting the production of film. As a result, the site where the Al—Ni-based compound has been produced gives film defect that causes pitting corrosion. However, since a number of finely divided film defects are to uniformly disperse on the surface of the sacrificial material, pitting corrosion occurs dispersedly to produce pits having a shallow depth, making it possible to prevent the development of through-holes. When the content of Ni falls below 0.4% by weight, the desired resistance against the pitting corrosion cannot be obtained. On the contrary, when the content of Ni exceeds 3.0% by weight, the resulting sacrificial material exhibits not only a raised corrodibility but also a deteriorated rollability. Thus, in the invention, the content of Ni in the sacrificial material is limited to a range of from 0.4% by weight to 3.0% by weight, preferably from 0.5% by weight to 1.2% by weight to attain the prevention of the development of through-holes and the enhancement of corrosion resistance and rollability at the same time.

The incorporation of Zn in the sacrificial material in an amount of from 1.0% by weight to 10.0% by weight causes the sacrificial material to be lower in its electric potential and hence maintain its sacrificial anode effect on the core material, making it possible to prevent the pitting corrosion of the core material or the gap corrosion. When the content of Zn falls below 1.0% by weight, a sufficient sacrificial anode effect on the core material cannot be exerted. On the contrary, when the content of Zn exceeds 10.0% by weight, the resulting sacrificial material exhibits a raised corrodibility (deteriorated corrosion resistance). Thus, in an embodiment of the invention, the content of Zn in the sacrificial material is limited to a range of from 1.0% by weight to 10.0% by weight, preferably from 1.5% by weight to 3.5% by weight to drastically attain the enhancement of the sacrificial anode effect on the core material and the deterioration of corrodibility at the same time.

The incorporation of Si in the sacrificial material in an amount of not smaller than 0.3% by weight to smaller than 0.5% by weight causes the enhancement of the strength thereof, making it possible to enhance the erosion and corrosion resistance thereof in an alkaline atmosphere. When the content of Si falls below 0.3% by weight, the resulting advantage of enhancing the erosion and corrosion resistance is reduced. On the contrary, when the content of Si is not smaller than 0.5% by weight, the resulting sacrificial material exhibits not only a deteriorated corrosion resistance (raised corrodibility) but also a deteriorated rollability. On the other hand, the sacrificial material for heat exchanger of the invention includes Fe incorporated therein in an amount of not greater than 0.25% by weight as an impurity to be unavoidably incorporated at the process for the production of the sacrificial material. It is normally known that when an Al—Si—Fe-based alloy satisfies the relationship that a value of {(amount of Si by weight)/(amount of F by weight)} almost equals to “2”, the cathode reaction on the surface of the material is inhibited, providing a high corrosion resistance. Therefore, in the embodiment of the invention, taking into account the aforementioned circumstances, including the requirements that the corrosion resistance of the sacrificial material be sufficiently secured, the content of Si in the sacrificial material is limited to a range of from not smaller than 0.3% by weight to smaller than 0.5% by weight.

The incorporation of Mg in the sacrificial material in an amount of from 0.5% by weight to 4.0% by weight causes Mg to be diffused in the core material during heat brazing at the process for the assembly of the heat exchanger, making it possible to enhance the strength of the core material jointly by Si or Cu incorporated in the core material. When the content of Mg falls below 0.5% by weight, the resulting effect of enhancing the strength of the core material is reduced. On the contrary, when the content of Mg exceeds 4.0% by weight, the resulting brazability is impaired. Therefore, in the embodiment of the invention, the aforementioned sacrificial material includes Mg incorporated therein in an amount of from 0.5% by weight to 4.0% by weight.

The incorporation of In in the sacrificial material in an amount of from 0.001% by weight to 0.050% by weight causes the sacrificial material to be lower in its potential and hence enhance its sacrificial anode effect on the core material, making it possible to prevent the pitting corrosion of the core material or the gap corrosion. When the content of In falls below 0.001% by weight, the resulting sacrificial anode effect is reduced. On the contrary, when the content of In exceeds 0.050% by weight, the resulting sacrificial material exhibits a raised corrodibility (deteriorated corrosion resistance) or a deteriorated rollability. In this case, at least one of deterioration of corrosion resistance and deterioration of rollability occurs. Therefore, in the embodiment of the invention, the aforementioned sacrificial material preferably includes In incorporated in an amount of from 0.001% by weight to 0.050% by weight.

The incorporation of Sn in the sacrificial material in an amount of from 0.001% by weight to 0.050% by weight causes the sacrificial material to be lower in its potential and hence enhance its sacrificial anode effect on the core material, making it possible to prevent the corrosion of the core material or the gap corrosion. When the content of Sn falls below 0.001% by weight, the resulting sacrificial anode effect is reduced. On the contrary, when the content of Sn exceeds 0.050% by weight, the resulting sacrificial material exhibits a raised corrodibility (deteriorated corrosion resistance) or a deteriorated rollability. Therefore, in the embodiment of the invention, the aforementioned sacrificial material preferably includes Sn incorporated in an amount of from 0.001% by weight to 0.050% by weight.

The incorporation of Mn in the core material constituting the aluminum alloy cladding material for heat exchanger causes the core material to be enhanced in its strength and higher in its potential, making the difference in potential from the sacrificial material larger and hence making it possible to enhance the corrosion resistance of the core material. When the content of Mn falls below 0.3% by weight, the resulting core material exhibits a reduced enhancement of strength and corrosion resistance. On the contrary, when the content of Mn exceeds 2.0% by weight, coarse compounds are produced during the casting of the core material to deteriorate the rollability of the core material, making it difficult to obtain a sound cladding material. Therefore, in the case of the aluminum alloy cladding material for heat exchanger of an embodiment of the invention, the content of Mn in the core material is limited to a range of from 0.3% by weight to 2.0% by weight, preferably from 0.5% by weight to 1.5% by weight to drastically attain the enhancement of the strength and corrosion resistance of the core material and the enhancement of the rollability of the core material at the same time.

The incorporation of Cu in the core material in an amount of from 0.1% by weight to 1.0% by weight causes the core material to be enhanced in its strength and higher in its potential, making the difference in potential from the sacrificial material and from the brazing material bigger and hence making it possible to enhance the corrosion protecting effect. Moreover, Cu in the core material is diffused in the sacrificial material and the brazing material during heat brazing to form a gentle concentration gradient, making the core material higher in its potential and the surface of the sacrificial material and the brazing material lower in its potential. Thus, a potential distribution that changes gently from the center of the thickness of the core material toward the surface of the sacrificial material and the brazing material is formed, rendering the core material entirely corrodible. When the content of Cu in the core material falls below 0.1% by weight, the resulting effect of enhancing the strength and corrosion resistance of the core material is reduced. On the contrary, when the content of Cu exceeds 1.0% by weight, the resulting core material exhibits a raised corrodibility (deteriorated corrosion resistance) or a lowered melting point that makes it easy for the core material to undergo local melting during brazing. Therefore, in the cladding material for heat exchanger of the embodiment of the invention, the content of Cu in the core material is limited to a range of from 0.1% by weight to 1.0% by weight, preferably from 0.3% by weight to 0.6% by weight to drastically attain the enhancement of the strength and the corrosion resistance of the core material and the inhibition of local melting during brazing at the same time.

The incorporation of Si in the core material in an amount of from 0.3% by weight to 2.0% by weight makes it possible to enhance the strength of the core material. In particular, in the case where Si and Mg are present, age hardening is allowed to occur after brazing, making it possible to enhance the strength of the core material. When the content of Si in the core material falls below 0.3% by weight, the resulting effect of enhancing the strength of the core material is reduced. On the contrary, when the content of Si exceeds 2.0% by weight, the resulting core material exhibits a raised corrodibility (deteriorated corrosion resistance) or a lowered melting point that makes it easy for the core material to undergo local melting during brazing. Therefore, in the cladding material for heat exchanger of the embodiment of the invention, the content of Si in the core material is limited to a range of from 0.3% by weight to 2.0% by weight, preferably from 0.5% by weight to 1.0% by weight to drastically attain the enhancement of the strength and the corrosion resistance of the core material and the inhibition of local melting during brazing at the same time.

The incorporation of Mg in the core material in an amount of from 0.03% by weight to 0.50% by weight makes it possible to enhance the strength of the core material. When the content of Mn in the core material falls below 0.03% by weight, the resulting effect of enhancing the strength of the core material is reduced. On the contrary, when the content of Mn exceeds 0.50% by weight, the resulting core material can be easily deteriorated in its brazability. In particular, in the case where brazing is effected in an inert gas atmosphere containing a fluoride-based flux, when the content of Mg exceeds 0.50% by weight, Mg reacts with the fluoride-based flux to impair brazability and produce a fluoride of Mg, making the external appearance of the brazed part poor. Therefore, in the aluminum alloy cladding material for heat exchanger of the embodiment of the invention, the core material preferably comprises Mg incorporated therein in an amount of from 0.03% by weight to 0.50% by weight. More preferably, the core material comprises Mg incorporated therein in an amount of from 0.03% to 0.10% by weight to drastically attain the enhancement of the strength and brazability of the core material at the same time.

The incorporation of Ti in the core material in an amount of from 0.05% by weight to 0.35% by weight causes the lamellar alternate formation of a high Ti region and a low Ti region in the thickness direction of the core material. Since the low Ti concentration region corrodes in preference to the high Ti concentration region, corrosion occurs in lamellar form to inhibit the progress of corrosion in the thickness direction, making it possible to enhance the corrosion resistance of the core material. When the content of Ti falls below 0.05% by weight, the resulting effect of enhancing corrosion resistance is reduced. On the contrary, when the content of Ti exceeds 0.35% by weight, huge crystallization products are produced during the casting of the core material, making it difficult to produce a sound cladding material.

Referring now to results of the experiments, which inventors made to confirm the advancement of the aluminum alloy cladding material for heat exchanger of the aforementioned fourth aspect of the invention, a description will be given in detail of a preferred embodiment of the invention.

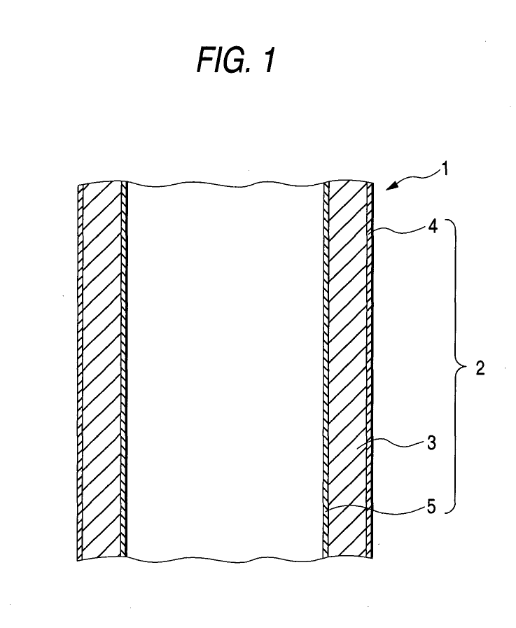

In the experiments, 50 specimens which are each a sheet material (H14) having a thickness of 0.25 mm having a sacrificial material 5 (see FIG. 1) made of an aluminum alloy having the formulation represented in Table 1 below, a core material 3 (see FIG. 1) made of an aluminum alloy having the formulation represented in Table 2 and a brazing material 4 (see FIG. 1) made of a JIS BA4343 material (aluminum alloy including 7.5% by weight of Si and the balance of Al and unavoidable impurities) provided in lamination were used. The sacrificial material 5 and the brazing material 4 constituting these specimens had a thickness of 0.038 mm (percentage of cladding: 15%) and 0.025 mm (percentage of cladding: 10%), respectively.

TABLE 1

| | | Formulation (wt-%) | | | | | | | |
|---|---|---|---|---|---|---|---|---|---|
| | Material | Essential component | | | Selective component | | | Impurities | |
| | symbol | Zn | Si | Ni | Mg | In | Sn | Fe | Al |
| Inventive | a | 1.5 | 0.35 | 0.5 | 3.5 | — | — | 0.02 | Balance |
| material | b | 9.0 | 0.45 | 2.5 | 0.6 | — | — | 0.02 | Balance |
| | c | 4.0 | 0.40 | 1.0 | 0.7 | 0.005 | 0.005 | 0.03 | Balance |
| | d | 4.0 | 0.40 | 1.0 | 1.5 | 0.040 | 0.010 | 0.03 | Balance |
| | e | 4.0 | 0.45 | 1.2 | 0.6 | 0.010 | 0.040 | 0.02 | Balance |
| Comparative | f | 7.0 | 0.20* | 2.0 | 0.7 | — | — | 0.02 | Balance |
| material | g | 0.5* | 0.40 | 2.0 | 0.4* | — | — | 0.03 | Balance |
| | h | 5.0 | 0.40 | 0.1* | 4.2* | 0.050 | 0.050 | 0.03 | Balance |

TABLE 2

| | | Formulation (wt-%) | | | | | | |
|---|---|---|---|---|---|---|---|---|
| | Material | Essential component | | | Selective component | | Impurities | |
| | symbol | Mn | Cu | Si | Ti | Mg | Fe | Al |
| Inventive | A | 0.35 | 0.15 | 0.5 | — | — | 0.02 | Balance |
| material | B | 0.50 | 0.90 | 0.4 | 0.06 | — | 0.02 | Balance |
| | C | 0.60 | 0.15 | 1.8 | — | 0.05 | 0.03 | Balance |
| | D | 1.50 | 0.30 | 0.5 | — | — | 0.02 | Balance |
| | E | 1.70 | 0.90 | 1.8 | 0.32 | 0.05 | 0.02 | Balance |
| | F | 1.70 | 0.50 | 0.5 | 0.06 | 0.45 | 0.03 | Balance |
| Comparative | G | 0.20* | 0.30 | 1.0 | — | — | 0.02 | Balance |
| material | H | 1.50 | 0.05* | 0.5 | — | — | 0.02 | Balance |
| | I | 1.70 | 0.50 | 0.2* | 0.05 | 0.05 | 0.03 | Balance |

Among 50 specimens set forth above, Specimen Nos. 1 to 26 represented in Table 3 each include a sacrificial material 5 made of any of the inventive materials “a” to “e” represented in Table 1 and a core material 3 made of any of the inventive materials “A” to “F” represented in Table 2 in combination.

TABLE 3

| | | | Evaluation | | | |
|---|---|---|---|---|---|---|
| | | | Maximum corrosion depth | | | |
| | | | (10⁻³ mm) | | Tensile | |
| Specimen | Sacrificial | Core | Corrosion | Corrosion | strength | |
| No. | material | material | test 1 | test 2 | (MPa) | Brazability |
| 1 | a | A | 198 | 215 | 178 | Good |
| 2 | a | B | 188 | 210 | 191 | Good |
| 3 | a | C | 175 | 206 | 206 | Good |
| 4 | a | D | 163 | 205 | 185 | Good |
| 5 | a | E | 153 | 203 | 210 | Good |
| 6 | a | F | 125 | 198 | 225 | Good |
| 7 | b | A | 69 | 81 | 179 | Good |
| 8 | b | B | 66 | 80 | 186 | Good |
| 9 | b | C | 62 | 78 | 192 | Good |
| 10 | b | E | 59 | 75 | 198 | Good |
| 11 | b | F | 52 | 71 | 202 | Good |
| 12 | c | A | 161 | 182 | 176 | Good |
| 13 | c | B | 151 | 179 | 179 | Good |
| 14 | c | C | 140 | 172 | 181 | Good |
| 15 | c | E | 139 | 169 | 196 | Good |
| 16 | c | F | 121 | 166 | 201 | Good |
| 17 | d | A | 112 | 115 | 185 | Good |
| 18 | d | B | 106 | 110 | 186 | Good |
| 19 | d | C | 105 | 108 | 200 | Good |
| 20 | d | E | 97 | 103 | 203 | Good |
| 21 | d | F | 87 | 101 | 218 | Good |
| 22 | e | A | 136 | 99 | 180 | Good |
| 23 | e | B | 129 | 96 | 182 | Good |
| 24 | e | C | 128 | 92 | 184 | Good |
| 25 | e | E | 123 | 91 | 197 | Good |
| 26 | e | F | 115 | 90 | 199 | Good |

Among 50 specimens represented above, Specimen Nos. 27 to 50 represented in Table 4 below are comparative examples (Nos. 27 to 35), which each include a sacrificial material 5 made of any of the inventive materials “a” to “e” represented in Table 1 and a core material 3 made of any of the comparative materials (“G” to “I”) represented in Table 2 in combination and comparative examples (Nos. 36 to 50) which each include a sacrificial material 5 made of any of the inventive materials “f” to “h” represented in Table 1 and a core material 3 made of any of the comparative materials (“A” to “F”) represented in Table 2 in combination.

TABLE 4

| | | | Evaluation | | | |
|---|---|---|---|---|---|---|
| | | | Maximum corrosion depth | | | |
| | | | (10⁻³ mm) | | Tensile | |
| Specimen | Sacrificial | Core | Corrosion | Corrosion | strength | |
| No. | material | material | test 1 | test 2 | (MPa) | Brazability |
| 27 | a | G | Pierced | 183 | 166 | Good |
| 28 | a | H | Pierced | 135 | 172 | Good |
| 29 | a | I | 165 | 162 | 156 | Good |
| 30 | b | G | Pierced | 152 | 161 | Good |
| 31 | b | H | Pierced | 148 | 169 | Good |
| 32 | b | I | 188 | 82 | 144 | Good |
| 33 | c | G | Pierced | 42 | 157 | Good |
| 34 | c | H | Pierced | 68 | 166 | Good |
| 35 | c | I | 140 | 55 | 141 | Good |
| 36 | f | A | 162 | Pierced | 159 | Good |
| 37 | g | A | Pierced | Pierced | 132 | Good |
| 38 | h | A | 155 | Pierced | 181 | Poor |
| 39 | f | B | 149 | Pierced | 168 | Good |
| 40 | g | B | 158 | Pierced | 143 | Good |
| 41 | h | B | 139 | Pierced | 192 | Poor |
| 42 | f | C | 198 | Pierced | 163 | Good |
| 43 | g | C | 178 | Pierced | 140 | Good |
| 44 | h | C | 142 | Pierced | 188 | Poor |
| 45 | f | E | 112 | Pierced | 174 | Good |
| 46 | g | E | 169 | Pierced | 151 | Good |
| 47 | h | E | 78 | Pierced | 199 | Poor |
| 48 | f | F | 175 | Pierced | 165 | Good |
| 49 | g | F | 186 | Pierced | 142 | Good |
| 50 | h | F | 123 | Pierced | 189 | Poor |

The symbol “*” in the column “comparative material” of Tables 1 and 2 indicates that the content of the alloying components deviate from the scope of the aforementioned fourth aspect of the invention. The various specimens of cladding material 2 were each subjected to brazing test, first and second corrosion test and tensile strength test. For the brazing test among these tests, a fin material obtained by corrugating a sheet material having a thickness of 0.10 mm made of an aluminum alloy including 1.2% by weight of Mn, 1.5% by weight of Zn and the balance of Al and unavoidable impurities was brazed to each of these specimens on the brazing material side thereof. The brazing was carried out by heating the specimen to a temperature of about 600° C. (material temperature) with a fluoride-based flux spread over the surface of the brazing material 4 in a nitrogen gas atmosphere. In the brazing test, the specimen thus brazed was visually observed for bonding to fin and observed for section texture to see if melting occurred in the core material 3 and the sacrificial material 5. Thus, brazability was evaluated.

For the first and second corrosion tests, the various specimens were each heated under the same conditions as in the aforementioned brazing test with a fluoride-based flux with no fin material put on one side thereof. In the first corrosion test (“corrosion test 1”), an aqueous solution containing 195 ppm of Co⁻, 60 ppm of SO₄²⁻, 1 ppm of Cu²⁺ and 30 ppm of Fe³⁺ was used as a corrosive liquid. The specimen was dipped in the corrosive liquid that had been heated to a temperature of 88° C. on the sacrificial material side thereof, which becomes inner side surface when the specimen is formed cylindrically, for 8 hours, and then cooled to a temperature of 25° C. where the specimen was then kept for 16 hours. The above-described cycle was repeated for 1 month. After the termination of the experiment, the specimen was withdrawn, and then observed for occurrence of through-holes by corrosion (piercing corrosion) and measured for maximum corrosion depth on the sacrificial material side thereof.

In the second corrosion test (“corrosion test 2”), a corrosion liquid obtained by further adjusting an aqueous solution containing 195 ppm of Co⁻, 60 ppm of SO₄²⁻, 1 ppm of Cu²⁺ and 30 ppm of Fe³⁺ with NaOH to pH 10 was circulated. A continuous operation was conducted at a temperature of 88° C. for 168 hours (1 week) with the corrosive liquid hitting the surface of the specimen on the sacrificial material side thereof in the piping for circulating the corrosive liquid. After the termination of the experiment, the specimen was withdrawn, and then observed for occurrence of through-holes by pitting corrosion and measured for maximum corrosion depth on the sacrificial material side thereof.

For the tensile strength test, tensile strength with respect to maximum tensile load was measured under the conditions that a dumbbell specimen of JIS No. 13B is pulled at a rate of 5 mm/min using a universal testing machine (Autograph AG-100kND) produced by Shimadzu Corporation.

The results of the first and second corrosion tests, the brazing test and the tensile strength test thus conducted are represented in Tables 3 and 4 above. In the column “brazability” of Tables 3 and 4, the term “Good” indicates that the brazed part shows a good bonding state and melting occurred neither in the core material 3 nor the sacrificial material 5. The term “Poor” indicates that the brazed part shows a poor bonding state and melting occurred in at least one of the core material 3 and the sacrificial material 5.

As can be seen in the experimental results represented in Table 3, all the examples each including a sacrificial material 5 made of the inventive material represented in Table 1 above and a core material 3 made of the inventive material represented in Table 2 in combination showed a good bonding state at the brazed part and no melting in the core material 3 and the sacrificial material 5. Further, at the first corrosion test, all these examples showed a maximum corrosion depth of not greater than 0.20 mm, which is smaller than the thickness of the cladding material (0.25 mm), and thus underwent no piercing corrosion. Moreover, at the second corrosion test, all the examples showed a maximum corrosion depth of not greater than 0.22 mm, which is smaller than the thickness of the cladding material (0.25 mm), and thus underwent no piercing corrosion. As a result, it was confirmed that the aluminum alloy cladding material for heat exchanger corresponding to the fourth aspect of the invention is provided with an excellent brazability and is also provided with an excellent corrosion resistance even when used in an alkaline or acidic atmosphere. Moreover, the examples showed a high tensile strength at the tensile strength test, making it possible to confirm that the aluminum alloy cladding material for heat exchanger corresponding to the fourth aspect of the invention is provided with a high tensile strength.

As defined in the experimental results represented in Table 4, on the contrary, the comparative examples deviating from the scope of the aluminum alloy cladding material for heat exchanger corresponding to the fourth aspect of the invention were inferior to the aforementioned examples in any of corrosion resistance, brazability and mechanical strength. For example, Comparative Example Nos. 27, 30 and 33, which had a small content of Mn in the core material 3, showed a poor corrosion resistance against acid. Comparative Example Nos. 28, 31 and 34, which had a small content of Cu in the core material 3, showed a poor corrosion resistance against acid. Therefore, the comparative examples (Nos. 27, 28, 30, 31, 33, 34) underwent piercing corrosion at the first corrosion test. Further, Comparative Example Nos. 29, 32 and 35, which had a small content of Si in the core material 3, showed a poor mechanical strength. Therefore, these comparative examples showed a reduced tensile strength at the tensile strength test.

Further, Comparative Example Nos. 36, 39, 42, 45 and 48, which had a small content of Si in the sacrificial material 5, showed a poor corrosion and erosion resistance against alkali. Therefore, the comparative examples (Nos. 36, 39, 42, 45, 48) underwent piercing corrosion at the second corrosion test. Comparative Example Nos. 37, 40, 43, 46 and 49, which had a small content of Zn in the sacrificial material 5 as well as a small content of Mg in the sacrificial material 4, showed not only a poor corrosion and erosion resistance against alkali but also a poor mechanical strength. Therefore, the comparative examples (Nos. 37, 40, 43, 46, 49) not only underwent piercing corrosion at the second corrosion test but also showed a reduced tensile strength at the tensile strength test. Comparative Example Nos. 38, 41, 44, 47 and 50, which had a small content of Ni in the sacrificial material 5 as well as a small content of Mg in the sacrificial material 5, showed not only a poor erosion and corrosion resistance against alkali but also a poor brazability. Therefore, the comparative examples (Nos. 38, 41, 44, 47, 50) not only underwent no piercing corrosion at the second corrosion test but also showed a poor brazability.

The sacrificial material for heat exchanger and aluminum alloy cladding material for heat exchanger of the invention have the aforementioned constitution and action and thus can realize a cladding material for heat exchanger having an excellent erosion and corrosion resistance against alkali. As a result, the aforementioned sacrificial material for heat exchanger and cladding material for heat exchanger can be used to form the constituents of aluminum heat exchanger such as radiator and heater core, particularly heat transfer pipe.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A sacrificial material for heat exchanger made of aluminum alloy comprising, by weight percent, 1.0% to 10.0% of Zn, 0.3% to 0.5% of Si and 0.4% to 3.0% of Ni, with the balance being aluminum including unavoidable impurities.

2. The sacrificial material as claimed in claim 1, further comprising, by weight percent, 0.5% to 4.0% of Mg.

3. The sacrificial material as claimed in claim 1, further comprising at least one of, by weight percent, 0.001% to 0.050% of In and 0.001% to 0.050% of Sn.

4. An aluminum alloy cladding material for heat exchanger comprising:
a core material made of aluminum alloy comprising, by weight percent, 0.3% to 2.0% of Mn, 0.1% to 1.0% of Cu and 0.3% to 2.0% of Si, with the balance being aluminum including unavoidable impurities; and
a sacrificial material made of aluminum alloy provided on one surface of the core material, wherein the sacrificial material comprising, by weight percent, 1.0% to 10.0% of Zn, 0.3% to 0.5% of Si and 0.4% to 3.0% of Ni, with the balance being aluminum including unavoidable impurities.

5. The aluminum alloy cladding material as claimed in claim 4, wherein the core material further comprising at least one of, by weight percent, 0.03% to 0.50% of Mg and 0.05% to 0.35% of Ti.

6. The aluminum alloy cladding material as claimed in claim 4, further comprising a brazing material made of Al—Si-based aluminum alloy laminated on the core material on a surface thereof opposite the sacrificial material.

7. The aluminum alloy cladding material as claimed in claim 4, wherein the sacrificial material further comprises 0.5% to 4.0% by weight of Mg.

8. The aluminum alloy cladding material as claimed in claim 4, wherein the sacrificial material further comprises at least one of, by weight percent, 0.001% to 0.050% of In and 0.001% to 0.050% of Sn.
